(19) United States
(12) Patent Application Publication
(10) Pub. No.: US 2015/0054242 A1
(43) Pub. Date: Feb. 26, 2015

(54) Apparatus and Method for Transporting a Patient in a Wheelchair

(71) Applicant: Melvin G. Hector, JR., Tucson, AZ (US)

(72) Inventor: Melvin G. Hector, JR., Tucson, AZ (US)

(21) Appl. No.: 14/461,246

(22) Filed: Aug. 15, 2014

Related U.S. Application Data
(60) Provisional application No. 61/867,503, filed on Aug. 19, 2013.

(51) Int. Cl. A61G 5/12; B62B 5/04

(52) U.S. Cl. CPC A61G 5/12; B62B 5/0485; A61G 2005/128
USPC 280/79.11

(57) ABSTRACT

A new and useful apparatus and method are provided for assisting in transporting a patient in a wheelchair to a desired location, where the wheelchair does not include foot rests. The apparatus comprises a platform for supporting a patient's feet and rollers that enable the platform to roll along a surface while the patient's feet are supported on the platform as an attendant moves the wheelchair with the seated patient to a desired location. The platform is configured to be selectively placed in an immobilizing position in which the platform is immobilized against movement until released, and the platform can be selectively released from the immobilizing position and is thereafter operational to roll along a surface with the patient's feet maintained thereon when the patient is being moved to the desired location.

### RELATED APPLICATION/CLAIM OF PRIORITY

This application is related to and claims priority from U.S. provisional Ser. No. 61/867,503, filed Aug. 19, 2013, which provisional application is incorporated by reference herein.

### BACKGROUND AND SUMMARY OF THE INVENTION

Many patients who use wheelchairs propel themselves for short distances by using their feet along with their upper extremity propulsion by turning the wheelchair wheels with their hands, and do not truly require leg rests; indeed, for short distances, leg rests would only impede their ability to move the chair in their immediate vicinity with the help of their feet and legs. However, when schedules require those same patients to be moved longer distances within the facility, it is a very common practice for attendants to ask the patients to simply hold their feet off of the floor while they are being pushed rapidly to their destination. Since this is an effort for the patient, the attendant tries to be expeditious, which in turn only means a faster pace. At these relatively high speeds, if the patient becomes exhausted, their feet drop to the level of the floor, and with the no-skid footwear used in most facilities, the patient's footwear grip the floor, folding them under their body and chair at such high speeds, that they “roll” the patient under the chair, effectively propelling these frail individuals into the floor's surface with enough energy to result in serious injuries.

The present invention is directed towards the prevention of injuries sustained by patients when they are propelling themselves or are propelled across longer-than-typical distances as they hold their feet above the floor's surface, and finally through exhaustion or error let their footwear touch the ground in transit, resulting in immediate injuries such as nail abruptions, toe or foot lacerations or fractures, ankle fractures or sprains, or even more severe injuries as the patient is thrown forward out of the chair entirely, to impact on the floor's surface. The present invention provides a large enough lightweight platform with a smooth upper surface for foot placement, a series of rollers underneath that allow travel across thresholds and height differences between floor surfaces, that can be easily adjusted to be immobile when necessary, or rolling when required.

More specifically, the present invention relates to an apparatus and a method for assisting in transporting a patient in a wheelchair to a desired location, where the wheelchair does not include foot rests. The apparatus comprises a platform for supporting a patient's feet and rollers that enable the platform to roll along a surface while the patient's feet are supported on the platform as an attendant moves the wheelchair with the seated patient to a desired location. The platform is configured to be selectively placed in an immobilizing position in which the platform is immobilized against movement until released, and the platform can be selectively released from the immobilizing position and is thereafter operational to roll along a surface with the patient's feet maintained thereon when the patient is being moved to the desired location.

Preferably, the platform has an immobilizing mechanism that is pivotally connected to the platform. The immobilizing mechanism is pivotal between a locked position in which it engages a surface and immobilizes the platform against movement and an unlocked position in which it is released from engagement with the surface and enables the platform to roll along a surface as an attendant wheels the wheelchair and patient to the desired location.

Thus, the present invention provides a platform with a flat surface upon which the patient can rest their feet that is solidly held in place on the floor with an immobilizing mechanism (that can comprise, e.g. retractable non-skid elements that retract when the patient is ready to be moved), allowing rollers on the bottom of the platform to enable the patient's feet to be rolled without their effort to their more distant location. Once there, the platform can then be removed and stored, or locked in place where the patient is located, until the patient is returned to their own typical environment (using the rolling platform again), and once again the patient is disengaged from the device.

Thus, a primary object of the present invention to provide a device that can be placed under the patient's feet that secures to the floor when it is not intended to roll, yet easily disengages from the floor's surface to provide a comfortable rolling surface that support's the patient's feet during transport, eliminating the possibility that the patient's feet will drag on the floor surface and result in an injury.

Another object of this invention is that it is reusable, durable, transferable between patients, able to be stacked in suitable racks at the destination of a given excursion so that they are readily available for immediate use at any time.

Still another object of this invention is that it simplifies the care of a given patient and their attendant, so that they need no longer worry about the possibility of injuring their patient during transport.

A further object of this invention is that it eliminates one more source of a patient's insecurity in terms of feeling vulnerable to falling during transport.

Yet another object of this invention is to extend the range of a frail elderly patient's travel by allowing them to go within the facility that they could not go before, because they could not hold their feet up long enough for the trip.

Further features of the present invention will become apparent from the following detailed description and the accompanying drawings.

### BRIEF DESCRIPTION OF THE DRAWINGS

FIG. 1 is a schematic illustration of a patient being taken in a wheelchair to a desired location, using a platform, according to the principles of the present invention:

FIGS. 2a-2c show top and side views of a platform that can be used in transporting a patient to a desired location, according to the principles of the present invention;

FIGS. 3a, 3b show the underside and front views, respectively, of the platform for transporting a patient to a desired location, according to the present invention;

FIGS. 4a, 4b show further details of the underside of the platform for transporting a patient to a desired location, according to the present invention; and

FIGS. 5a, 5b show further details of the platform, particularly the underside and side views of the platform, and FIG. 5b is an enlargement of the area 5b in FIG. 5a, and more specifically illustrating the manner in which the platform is immobilized against a surface, in accordance with the principles of the present invention.

### DETAILED DESCRIPTION

As discussed above, the present invention relates to an apparatus and a method for assisting in transporting a patient in a wheelchair to a desired location, where the wheelchair does not include foot rests. The present invention addresses specifically the situation where an attendant might ask the patient to simply hold their feet off of the floor while they are being pushed rapidly to their destination. Since this is an effort for the patient, the attendant tries to be expeditious, which in turn only means a faster pace. At these relatively high speeds, if the patient becomes exhausted, their feet drop to the level of the floor, and with the no-skid footwear used in most facilities, the patient's feet then grip the floor, folding them under their body and chair at such high speeds, that they “roll” the patient under the chair, effectively propelling these frail individuals into the floor's surface with enough energy to result in serious injuries.

The present invention is described herein in connection with several exemplary types of platforms that are useful in the practice of the invention, and from that description, the manner in which the present invention can be practiced with other types of platforms will be apparent to those in the art.

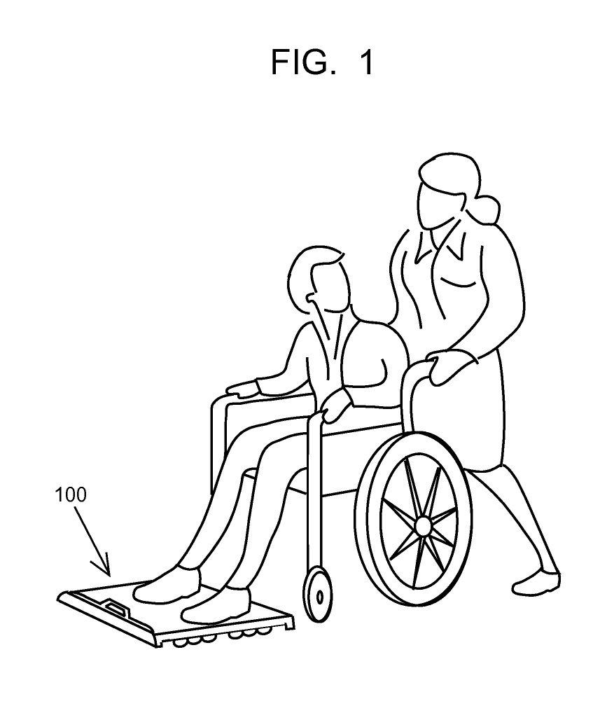

FIG. 1 is a schematic illustration of a patient being taken in a wheelchair to a desired location, using a platform 100, according to the principles of the present invention. The patient's feet are both supported on the top surface of the platform 100 and the platform has rollers on its bottom side, so that the patient's legs are supported on the rolling platform as the patient is being wheeled to the desired location.

The platform 100 is configured to be selectively placed in an immobilizing position in which the platform is immobilized against movement until released, and the platform can be selectively released from the immobilizing position and is thereafter operational to roll along a surface with the patient's feet maintained thereon when the patient is being moved to the desired location.

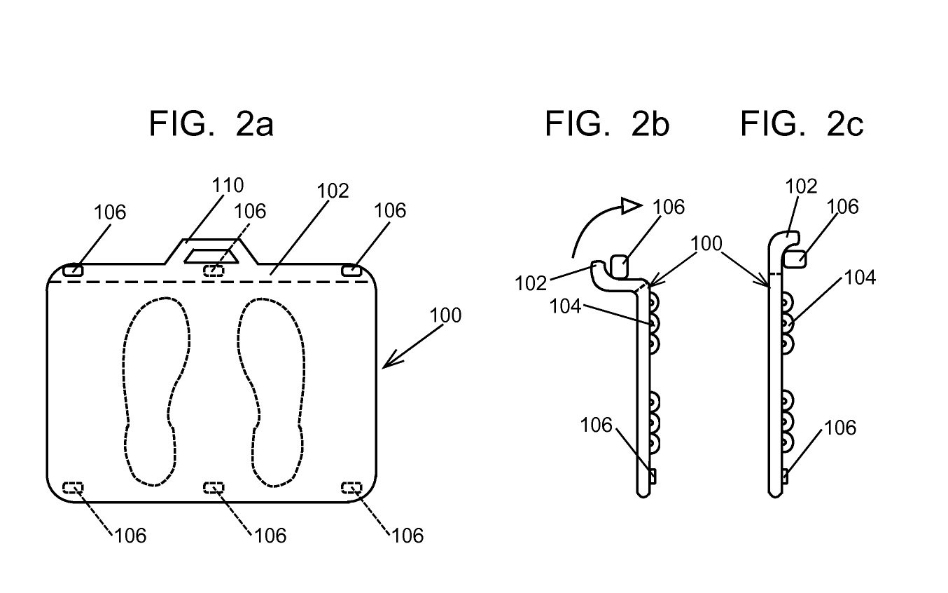

Specifically, as schematically illustrated in FIGS. 2a-2c, the underside of the platform has a series of rollers 104 that enable the platform to roll along a surface as the patient is being wheeled to the desired location. In addition, the platform has a portion 102 that can pivot in the manner illustrated (particularly in FIGS. 2b and 2c), to either place the platform in an immobilizing position in which it is immobilized against the surface over which it was rolling, or to release the platform to enable it to roll along the surface. The portion 102 has one or more nonskid elements 106 that are raised above the surface when the platform is rolling along the surface (see e.g. FIG. 2b) and which are brought into contact with the surface to immobilize the platform when the portion 102 is pivoted to a locked or immobilizing position (e.g. as shown in FIG. 2c). In addition, there are additional nonskid elements 106 on the side of the platform opposite from the portion 102, that are utilized to immobilize the platform when the portion 102 is pivoted, as described in more detail below

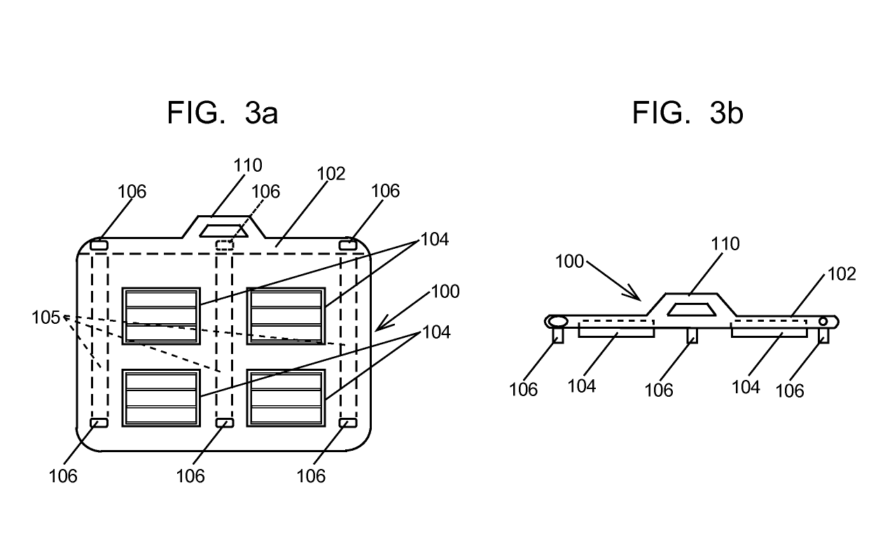

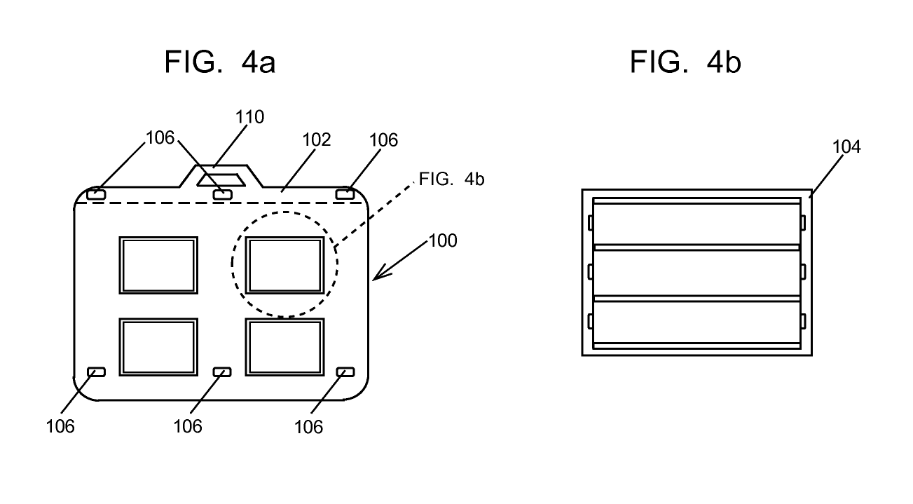

FIGS. 3a, 3b show the underside front views of the platform for transporting a patient to a desired location, according to the present invention. In FIGS. 3a, 3b the rollers 104 are shown as sets of roller elements. FIGS. 4a, 4b show additional details of the rollers 104 that form the roller sets.

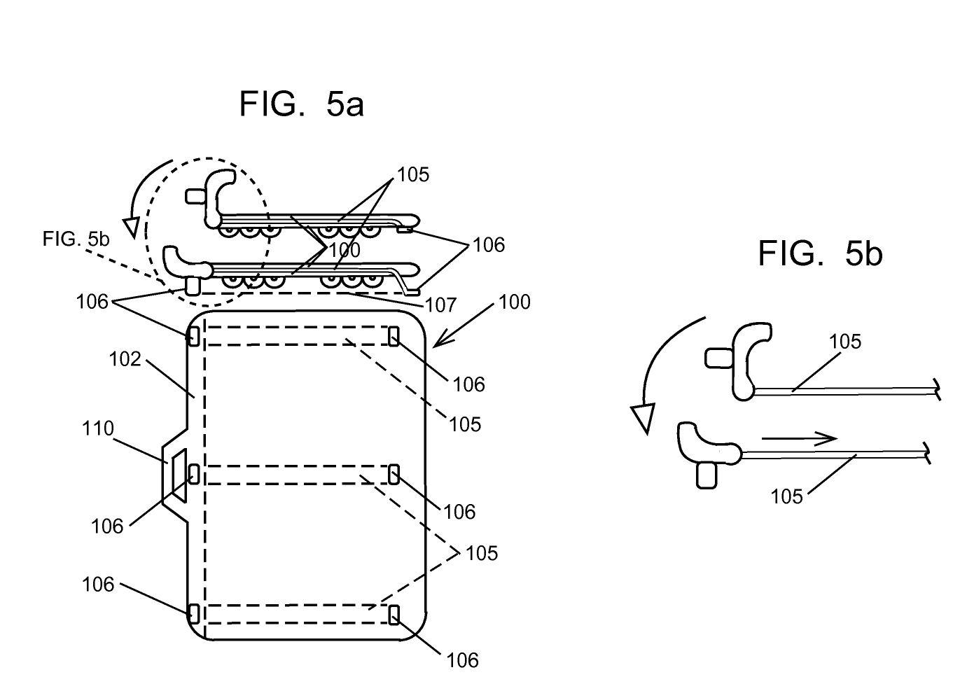

FIGS. 5a, 5b show further details of the manner in which the nonskid elements 106 on the side of the platform opposite to the pivotal member 102 are operated to immobilize the platform when the pivotal member 102 is pivoted, in accordance with the principles of the present invention. FIG. 5a shows a top view and a pair of side views of the platform, and FIG. 5b is an enlarged fragmentary view of the area 5b in the side views. The platform 100 has flexible members 105 that extend from adjacent the pivotal member 102 to respective nonskid members 106 on the side of the platform opposite the pivotal member 102. The flexible members 105 can move inside the platform 100, and the underside of the platform, on the opposite side of the platform from the pivotal member 102, has openings for the flexible members 105. The flexible members 105 are biased toward a position that raises them above a surface, when the pivotal member is in a vertical position (the side views in FIG. 5a). When the pivotal member 102 is pivoted to the horizontal position (the middle side view in FIG. 5a), it urges the flexible members 105 toward the right in FIGS. 5a and 5b, to bring the nonskid members 106 on the pivotal member into engagement with a surface. Specifically, the pivotal member 102 acts on the flexible members 105 (in a manner similar to that of a cam and cam follower) to urge the flexible members 105 against their bias and in a direction (toward the right in FIGS. 5a and 5b) and through the openings in the underside of the platform 100, to push and hold the nonskid members 106 against the surface (shown at 107 in FIG. 5a), to immobilize the platform 100. When the member 102 is pivoted to the vertical positions shown in FIGS. 5a and 5b, it allows the flexible members to return under their bias to a position (the top positions in FIGS. 5a and 5b) where the nonskid members 106 are raised above the surface.

As seen from the foregoing description, the present invention provides an injury protection device for placement under the feet of a wheelchair-bound resident who does not usually use foot or leg rests, to facilitate their safe transport from one part of the facility to another. The invention provides a flat platform on wheels that is made out of plastic or other composite materials that provides a place for the patient's feet to rest while being pushed to another destination by an attendant, thus avoiding the need for the patient to suspend his feet above the floor's surface for the duration of that trip, and avoiding the falls that often happen when that patient tires of holding their feet up and touches the floor surface while in motion, pulling their feet underneath them and themselves under their chair and resulting in propelling the patient into the floor with injurious falls.

While the present invention is preferably designed for use with an attendant in a facility for most patients, it is completely within the capability of a patient to assign the present invention to an individually capable patient for them to use this device safely themselves for the purpose it is intended.

It is also useful to note that the platform 100 has a handle 110 that enables the platform to be carried conveniently to and from a wheel chair with which it is used.

Thus, the foregoing detailed description provides an apparatus and method designed to enable a patient to be safely transported in a wheelchair to a desired location. With the foregoing disclosure in mind, the manner in which an apparatus can be designed, and a method practiced, to transport a patient safely in a wheelchair to a desired location will be apparent to those in the art.

1. A method for assisting in transporting a patient in a wheelchair to a desired location, where the wheelchair does not include foot rests, comprising seating the patient in the wheelchair, positioning both of the patient's feet on a platform that is maintained immobile until released, the platform when released being configured to be rolled along a surface with the patient's feet maintained thereon until the wheelchair with the seated patient reaches a desired location, and optionally immobilizing or removing the platform at the desired location.

2. The method of claim 1, wherein the platform has a locking mechanism that is pivotally connected to the platform, the locking mechanism being pivotal between a locked position in which the locking mechanism engages a surface and immobilizes the platform against movement and an unlocked position in which it is released from engagement with the surface and enables the platform to roll along a surface as an attendant wheels the wheelchair and patient to the desired location

3. Apparatus for assisting in transporting a patient in a wheelchair to a desired location, where the wheelchair does not include foot rests, the apparatus comprising a platform for supporting a patient's feet and rollers that enable the platform to roll along a surface while the patient's feet are supported on the platform as an attendant moves the wheelchair with the seated patient to a desired location, and the platform configured to be selectively placed in an immobilizing position in which the platform is immobilized against movement until released, the platform being configured to be selectively released from the immobilizing position and thereafter being operational to roll along a surface with the patient's feet maintained thereon when the patient is being moved to the desired location.

4. The apparatus of claim 2, wherein the platform has a locking mechanism that is pivotally connected to the platform, the locking mechanism being pivotal between a locked position in which the locking mechanism engages a surface and immobilizes the platform against movement and an unlocked position in which it is released from engagement with the surface and enables the platform to roll along a surface as an attendant wheels the wheelchair and patient to the desired location

5. A platform on which a patient's feet can rest that is immobile until it is unlocked, but once unlocked allows the patient's feet to be supported on the top of this platform, and be rolled to any intended destination within a facility without the necessity of having the patient hold their feet in the air, where, upon arrival, it can either be removed or locked again at that new location until further travel is warranted.
